(19) United States
(12) Patent Application Publication
(10) Pub. No.: US 2017/0266863 A1
(43) Pub. Date: Sep. 21, 2017

(54) ADDITIVE MANUFACTURING APPARATUS AND ADDITIVE MANUFACTURING METHOD

(71) Applicant: FUJI XEROX CO., LTD., Tokyo (JP)

(72) Inventors: Atsushi OGIHARA, Kanagawa (JP); Atsuyuki KITAMURA, Kanagawa (JP)

(73) Assignee: FUJI XEROX CO., LTD., Tokyo (JP)

(21) Appl. No.: 15/217,343

(22) Filed: Jul. 22, 2016

(30) Foreign Application Priority Data
Mar. 17, 2016 (JP) 2016-054368

(51) Int. Cl. B29C 47/06

(52) U.S. Cl. CPC B29C 47/06; B29K 2101/12

(57) ABSTRACT

An additive manufacturing apparatus includes a discharging unit that discharges resin powder into a molding tank; a supplying unit that supplies a fiber into the molding tank; and a solidifying unit that solidifies at least part of a resin layer including the fiber and formed in the molding tank.

### CROSS-REFERENCE TO RELATED APPLICATIONS

This application is based on and claims priority under 35 USC 119 from Japanese Patent Application No. 2016-054368 filed Mar. 17, 2016.

### BACKGROUND

The present invention relates to an additive manufacturing apparatus and an additive manufacturing method.

### SUMMARY

According to an aspect of the invention, there is provided an additive manufacturing apparatus including a discharging unit that discharges resin powder into a molding tank; a supplying unit that supplies a fiber into the molding tank; and a solidifying unit that solidifies at least part of a resin layer including the fiber and formed in the molding tank.

### BRIEF DESCRIPTION OF THE DRAWINGS

Exemplary embodiments of the present invention will be described in detail based on the following figures, wherein:

FIG. 1 is a schematic side view of an additive manufacturing apparatus according to a first exemplary embodiment;

FIGS. 2A to 2C are explanatory illustrations each showing a molding step of a three-dimensional molded part by the additive manufacturing apparatus according to the first exemplary embodiment;

FIGS. 3A to 3C are explanatory illustrations each showing a molding step of the three-dimensional molded part by the additive manufacturing apparatus according to the first exemplary embodiment;

FIG. 4 is a schematic side view of an additive manufacturing apparatus according to a second exemplary embodiment;

FIGS. 5A to 5C are explanatory illustrations each showing a molding step of a three-dimensional molded part by the additive manufacturing apparatus according to the second exemplary embodiment; and

FIGS. 6A to 6C are explanatory illustrations each showing a molding step of the three-dimensional molded part by the additive manufacturing apparatus according to the second exemplary embodiment.

### DETAILED DESCRIPTION

Exemplary embodiments of the present invention are described below in detail with reference to the drawings. For convenience of description, it is assumed that arrow UP properly shown in each drawing indicates the upward direction of an additive manufacturing apparatus 10 and arrow RH properly shown in each drawing indicates the rightward direction of the additive manufacturing apparatus 10. Also, it is assumed that the near-side direction toward the paper face of each drawing indicates the forward direction of the additive manufacturing apparatus 10.

### First Exemplary Embodiment

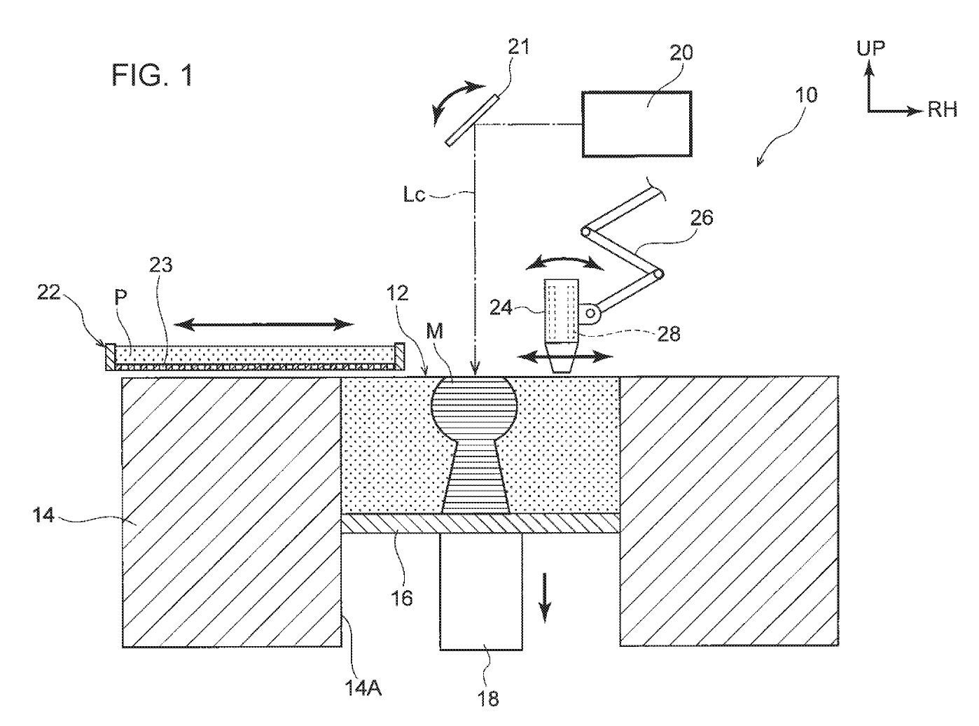

First, an additive manufacturing apparatus 10 according to a first exemplary embodiment is described. As shown in FIG. 1, the additive manufacturing apparatus 10 includes a molding tank 12 for molding a three-dimensional molded part M. The molding tank 12 includes an apparatus body 14 having an opening 14A with, for example, a circular shape; and a disk-shaped molding table 16 provided in the opening 14A of the apparatus body 14. The molding table 16 is provided movably upward and downward by a known up/down moving device 18, such as an air cylinder. The molding table 16 has an outer diameter determined to be able to slide relative to the inner peripheral surface of the opening 14A.

A reflector 21 is arranged above the molding tank 12. The reflector 21 may change its angle by a mechanism (not shown). A laser device 20 is arranged at a proper position. The laser device 20 serves as a solidifying unit that emits a laser beam Lc that provides scanning while reflected by the reflector 21. An example of the laser beam Lc emitted from the laser device 20 may be a laser beam of a carbon dioxide laser with a wavelength (for example, about 10 μm) that is likely absorbed by powder P made of resin (hereinafter, referred to as “resin powder”).

Further, a screen member 22 is arranged above the molding tank 12. The screen member 22 serves as an example of a discharging unit that discharges the resin powder P into the molding tank 12. A mesh plate 23 in a fine mesh form and an open/close plate (not shown) that opens and closes the mesh plate 23 are arranged at a bottom portion of the screen member 22. The open/close plate is opened at a position above the molding tank 12, and the resin powder P passing through the mesh plate 23 is discharged into the molding tank 12. An example of the resin powder P may be powder of thermoplastic resin.

Also, the screen member 22 is movable in a radial direction (the left-right direction in the drawing) of the molding tank 12, by a known moving mechanism (not shown). That is, the screen member 22 may take positions including a discharge position at which the screen member 22 is located above the molding tank 12 and discharges the resin powder P into the molding tank 12 (the mesh plate 23 is opened by the open/close plate), and a retraction position at which the screen member 22 is retracted from the position above the molding tank 12 and does not discharge the resin powder P into the molding tank 12 (the mesh plate 23 is closed by the open/close plate).

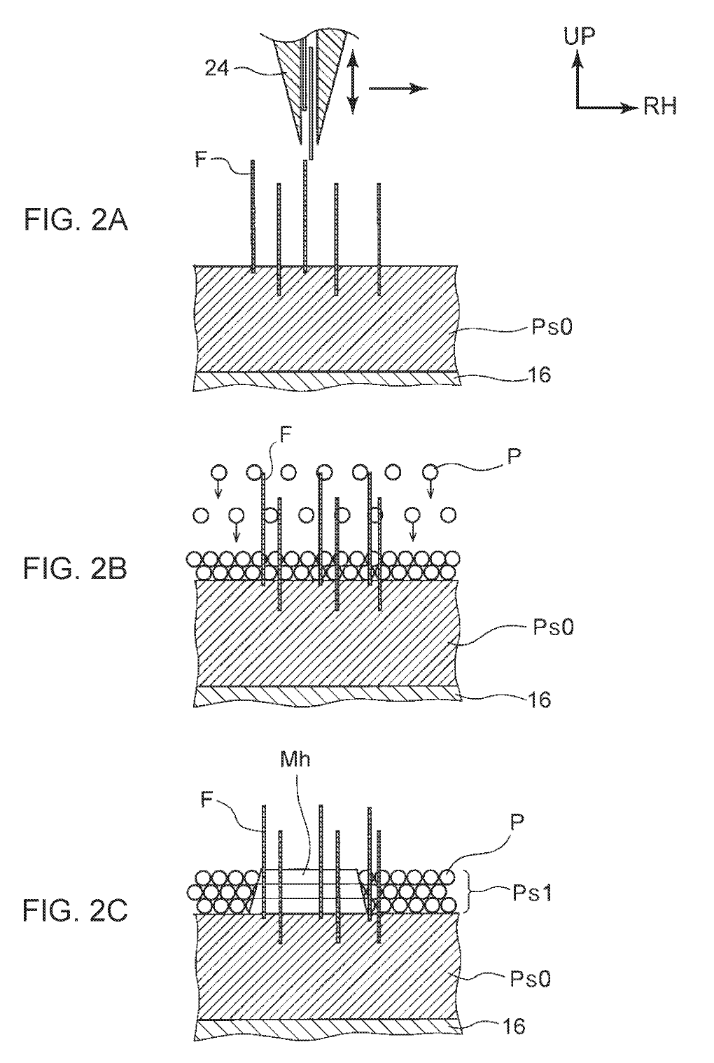

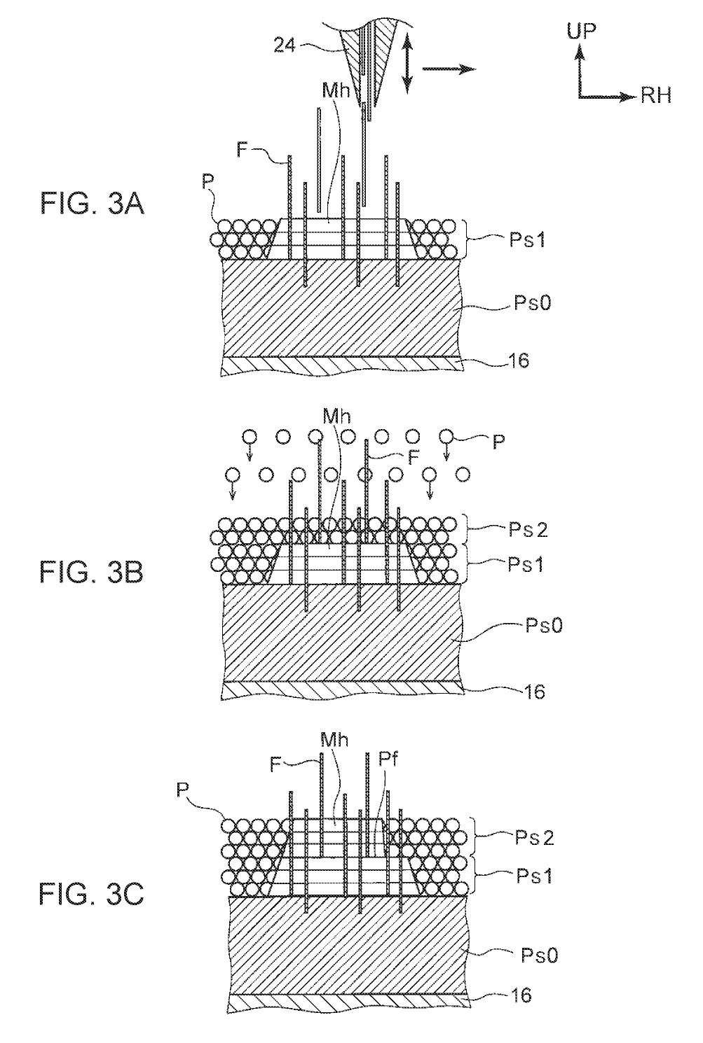

Also, a nozzle member 24 is arranged above the molding tank 12. The nozzle member 24 serves as an example of a supplying unit that ejects and supplies plural fibers F (see FIGS. 2A to 3C) into the molding tank 12 at once. An example of the fibers F may be carbon fibers or glass fibers. Regarding the fibers F in this exemplary embodiment, for example, in case of carbon fibers, the fibers F to be used have a diameter in a range from 0.005 mm to 0.01 mm, a length in a range from 0.5 mm to 1.0 mm, and a larger thickness than the layer thickness of a single layer of the resin powder P (described later).

The nozzle member 24 is mounted at a distal end portion of a robot arm 26, rotatably around a direction intersecting with the up-down direction as the axial direction. The robot arm 26 is movable in the radial direction (the left-right direction) of the molding tank 12. This movement may handle a change in the supply position and supply direction of the fibers F to be supplied into the molding tank 12 in accordance with molding data of the three-dimensional molded part M to be molded.

That is, since the robot arm 26 moves in the radial direction of the molding tank 12, the nozzle member 24 is able to supply the fibers F only to an area where the three-dimensional molded part M is formed (a region to be solidified by the laser device 20). Since the nozzle member 24 rotates around the direction intersecting with the up-down direction as the axial direction, this rotation may handle a change in the angle (the supply direction) of the fibers F to be supplied to the area where the three-dimensional molded part M is formed.

Also, the fibers F to be supplied by the nozzle member 24 are coated with a coating material made of resin (hereinafter, referred to as resin coating material, not shown). Hence, the nozzle member 24 includes a heater 28 serving as an example of a heating unit that heats and melts the fibers F together with the coating material. That is, in this first exemplary embodiment, the fibers F coated with the resin coating material are supplied into the molding tank 12 by fused deposition molding.

An operation with the additive manufacturing apparatus 10 according to the first exemplary embodiment configured as described above is described below.

The molding table 16 is arranged at an upper portion side of the molding tank 12 by the up/down moving device 18. In this state, when the screen member 22 is arranged at the discharge position located above the molding tank 12 and when the open/close plate is opened, the resin powder P is discharged into the molding tank 12. Accordingly, as shown in FIG. 2A, a layer of the resin powder P, that is, a lowermost resin layer Ps0 is formed on the molding table 16 in the molding tank 12 (the lowermost resin layer Ps0 is indicated by oblique lines). Then, after the resin layer Ps0 is formed on the molding table 16, the open/close plate is closed, the screen member 22 is retracted to the retraction position, and the nozzle member 24 supplies plural fibers F to the resin layer Ps0.

As described above, in the additive manufacturing apparatus 10 according to the first exemplary embodiment, the configuration is divided into the screen member 22 that discharges the resin powder P and the nozzle member 24 that supplies the fibers F. Hence, as compared with a configuration not divided into the screen member 22 that discharges the resin powder P and the nozzle member 24 that supplies the fibers F, the orientation and mixture ratio of the fibers F in the three-dimensional molded part M (condensation of the fibers F with respect to the resin powder P) are properly set.

In particular, since the nozzle member 24 is able to change the supply position and supply direction in accordance with the molding data of the three-dimensional molded part M, as compared with a configuration that is not able to change the supply position or supply direction, the orientation and mixture ratio of the fibers F in the three-dimensional molded part M are properly controlled. Also, the fibers F to be supplied by the nozzle member 24 are coated with the resin coating material. Hence, as compared with a configuration in which the fibers F are not coated with the resin coating material, the fibers F are smoothly supplied into the molding tank 12.

Further, the nozzle member 24 includes the heater 28 that heats the fibers F together with the coating material. For example, the fibers F supplied to the resin layer Ps0 are cooled, solidified, and hence fixed after the supply. Hence, as compared with a configuration not including the heater 28 that heats the fibers F, the orientation of the fibers F in the three-dimensional molded part M is properly ensured.

After the supply with the fibers F by the nozzle member 24 is ended, the screen member 22 is arranged at the discharge position again, and as shown in FIGS. 2B and 2C, the resin powder P is discharged into the molding tank 12 and laminated. That is, a resin layer Ps1 is formed on the resin layer Ps0. After the screen member 22 is retracted to the retraction position, as shown in FIG. 2C, the area supplied with the fibers F in the resin layer Ps1 is molten or sintered and solidified (a solidified portion Mh is formed) by the laser beam Lc (see FIG. 1), which is emitted from the laser device 20 and provides scanning while reflected by the reflector 21.

As described above, if only the area supplied with the fibers F in the resin layer Ps1 is solidified by the laser beam Lc, as compared with a configuration in which the nozzle member 24 supplies the fibers F to a region other than the region to be solidified by the laser beam Lc, the consumption of the fibers F is decreased, and hence the manufacturing cost of the three-dimensional molded part M is decreased. Also, when the resin powder P, which is not solidified and remains in the molding tank 12 after the three-dimensional molded part M is removed, is collected, the resin powder P not including the fibers F may be collected, and the resin powder P is smoothly sent to the screen member 22 (or a coater 32, described later) again.

Then, as shown in FIG. 3A, the nozzle member 24 supplies plural fibers F to the solidified portion Mh formed in the molding tank 12. At this time, since the fibers F are heated and molten by the heater 28, the fibers F are cooled after the supply, and hence fixed at the solidified portion Mh. As described above, as long as the fibers F are supplied before the resin powder P is discharged except for the lowermost resin layer Ps0, as compared with a configuration that supplies the fibers F after the resin powder P is discharged, the orientation of the fibers F is stabilized.

Alternatively, the nozzle member 24 may supply the fibers F in a state in which the area supplied with the fibers F in the resin layer Ps1 is molten by the laser beam Lc (after the solidification of the resin layer Ps1 by the laser beam Lc is started and before the solidification of the resin layer Ps1 is completed). Accordingly, as compared with a configuration in which the nozzle member 24 supplies the fibers F after the solidification of the area supplied with the fibers F in the resin layer Ps1 is completed (as compared with a configuration in which the fibers F are heated and fixed at the solidified portion Mh), the coupling force between the fibers F and the resin powder P is increased.

Then, as shown in FIG. 3B, the screen member 22 is arranged at the discharge position again, and the resin powder P is discharged into the molding tank 12 and laminated. That is, a resin layer Ps2 is formed on the resin layer Ps1. After the screen member 22 is retracted to the retraction position, as shown in FIG. 3C, the area supplied with the fibers F in the resin layer Ps2 is molten or sintered and solidified (the solidified portion Mh is increased) by the laser beam Lc, which is emitted from the laser device 20 and provides scanning while reflected by the reflector 21.

By successively repeating the above-described steps, the three-dimensional molded part M as shown in FIG. 1 is formed in the molding tank 12. Although the illustration is omitted, as the resin powder P discharged from the screen member 22 is laminated on the molding table 16, the molding table 16 is gradually moved downward by the up/down moving device 18.

Also, since the fibers F have a large length (for example, the length is 0.7 mm which is larger than a resin layer Ps), as compared with a configuration in which the fibers F have a small length (for example, the length is 0.1 mm which is smaller than the resin layer Ps), the tensile strength of the three-dimensional molded part M is increased. Also, since the resin powder P is the thermoplastic resin powder, as compared with a configuration in which the resin powder P is not the thermoplastic resin powder, the coupling force between the fibers F and the resin powder P is increased.

Also, as shown in FIG. 3C, the nozzle member 24 supplies at least part of the fibers F so that the fibers F extend over a layer interface Pf between the resin layer Ps1 and the resin layer Ps2 formed in the molding tank 12 (the layer interface Pf of the solidified portion Mh solidified by the laser beam Lc). Accordingly, as compared with a configuration in which the nozzle member 24 does not supply the fibers F so that the fibers F extend over the layer interface Pf between the resin layer Ps1 and the resin layer Ps2 formed in the molding tank 12, the molding strength and molding accuracy of the three-dimensional molded part M are increased.

### Second Exemplary Embodiment

Next, an additive manufacturing apparatus 10 according to a second exemplary embodiment is described. It is to be noted that the same reference sign is applied to the portion equivalent to that of the above-described first exemplary embodiment, and its detailed description is omitted.

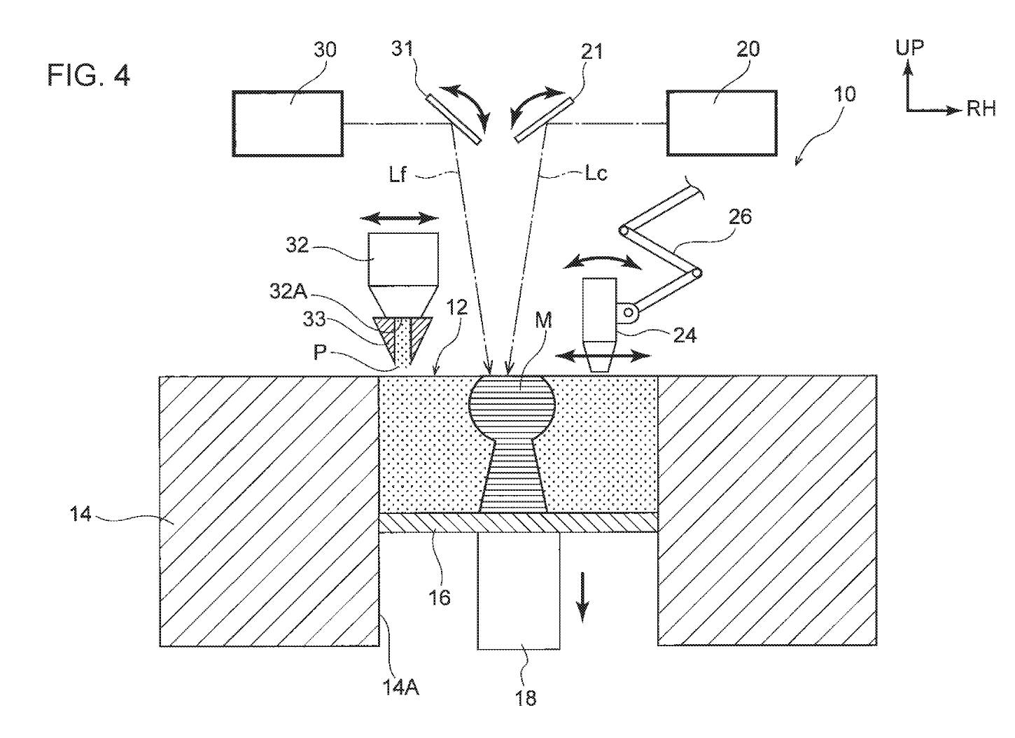

As shown in FIG. 4, in the additive manufacturing apparatus 10 according to the second exemplary embodiment, the resin powder P is discharged by a coater 32 serving as an example of a discharging unit. A blade 33 is provided around a discharge port 32A of the coater 32. The blade 33 restricts scattering of the resin powder P discharged from the discharge port 32A.

The coater 32 is movable in the radial direction (the left-right direction in the drawing) at the upper side of the molding tank 12, by a known moving mechanism (not shown). That is, the coater 32 discharges the resin powder P from above into the molding tank 12 by a constant amount while moving in the radial direction from one end portion to the other end portion of the molding tank 12.

The coater 32 temporarily stops discharging the resin powder P and moving in the radial direction at the other end portion of the molding tank 12, then moves to return to the one end portion of the molding tank 12, and discharges the resin powder P into the molding tank 12 while moving in the radial direction from the one end portion to the other end portion of the molding tank 12 again.

Also, a reflector 31 is arranged above the molding tank 12. The reflector 31 may change its angle by a mechanism (not shown). A laser device 30 is arranged at a proper position in addition to the laser device 20. The laser device 30 serves as a heating unit that emits a laser beam Lf that provides scanning while reflected by the reflector 31.

That is, in this second exemplary embodiment, the fibers F are heated by the laser beam Lf emitted from the laser device 30. Hence, in this second exemplary embodiment, the nozzle member 24 is not provided with the heater 28. An example of the laser beam Lf emitted from the laser device 30 may be a laser beam of a fiber laser with a wavelength (for example, about 1 μm) that is likely absorbed by the fibers F.

An operation with the additive manufacturing apparatus 10 according to the second exemplary embodiment configured as described above is described below. It is to be noted that description on the operation common to that of the above-described first exemplary embodiment is properly omitted.

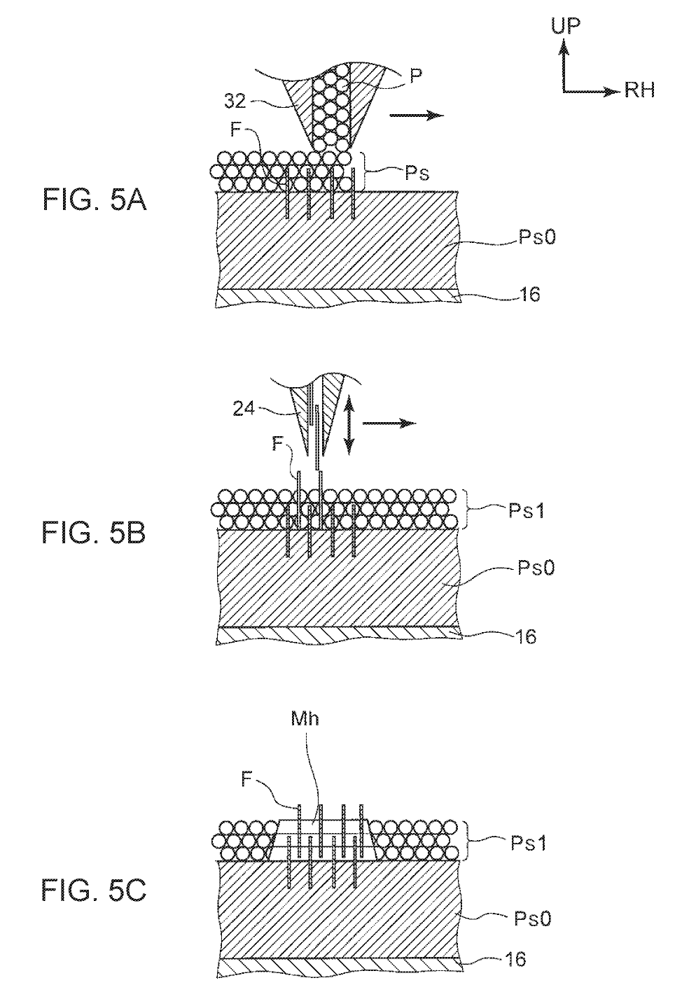

The molding table 16 is arranged at the upper portion side of the molding tank 12 by the up/down moving device 18. In this state, the coater 32 discharges the resin powder P while moving in the radial direction from the one end portion to the other end portion at the upper side of the molding tank 12, and hence a layer of the resin powder P, that is, a lowermost resin layer Ps0 (see FIG. 5A) is formed on the molding table 16 in the molding tank 12.

Then, after the resin layer Ps0 is formed on the molding table 16, the coater 32 moves to return to the one end portion of the molding tank 12, and the nozzle member 24 supplies plural fibers F to the resin layer Ps0. Then, the fibers F are heated and molted by the laser beam Lf, which is emitted from the laser device 30 and provides scanning while reflected by the reflector 31, and the fibers F are fixed to the resin layer Ps0.

As described above, also in the additive manufacturing apparatus 10 according to the second exemplary embodiment, the configuration is divided into the coater 32 that discharges the resin powder P and the nozzle member 24 that supplies the fibers F. Hence, as compared with a configuration not divided into the coater 32 that discharges the resin powder P and the nozzle member 24 that supplies the fibers F, the orientation and mixture ratio of the fibers F in the three-dimensional molded part M are properly set.

Then, as shown in FIG. 5A, the coater 32 discharges the resin powder P while moving in the radial direction from the one end portion to the other end portion at the upper side of the molding tank 12 again. Accordingly, a resin layer Ps1 is formed on the resin layer Ps0. Then, after the resin layer Ps1 is formed, the coater 32 moves to return to the one end portion of the molding tank 12, and the nozzle member 24 supplies plural fibers F to the resin layer Ps1 as shown in FIG. 5B.

Then, the fibers F are heated and molted by the laser beam Lf, which is emitted from the laser device 30 and provides scanning while reflected by the reflector 31, and the fibers F are fixed to the resin layer Ps1. As shown in FIG. 5C, the area supplied with the fibers F in the resin layer Ps1 is molten or sintered and solidified (a solidified portion Mh is formed) by the laser beam Lc, which is emitted from the laser device 20 and provides scanning while reflected by the reflector 21.

The fibers F are heated and molten by the laser beam Lf emitted from the laser device 30. Then, the fibers F are cooled, solidified, and hence fixed to the resin layer Ps1. Accordingly, as compared with a configuration not including the laser device 30 that emits the laser beam Lf, the orientation of the fibers F in the three-dimensional molded part M is properly ensured.

Also, the nozzle member 24 supplies the fibers F after the resin powder P is discharged, also for the lowermost resin layer Ps0. Hence, as compared with a configuration in which the nozzle member 24 supplies the fibers F before the resin powder P is discharged (excluding a situation before the lowermost resin layer Ps0 is formed), the coupling force between the fibers F and the resin powder P is increased.

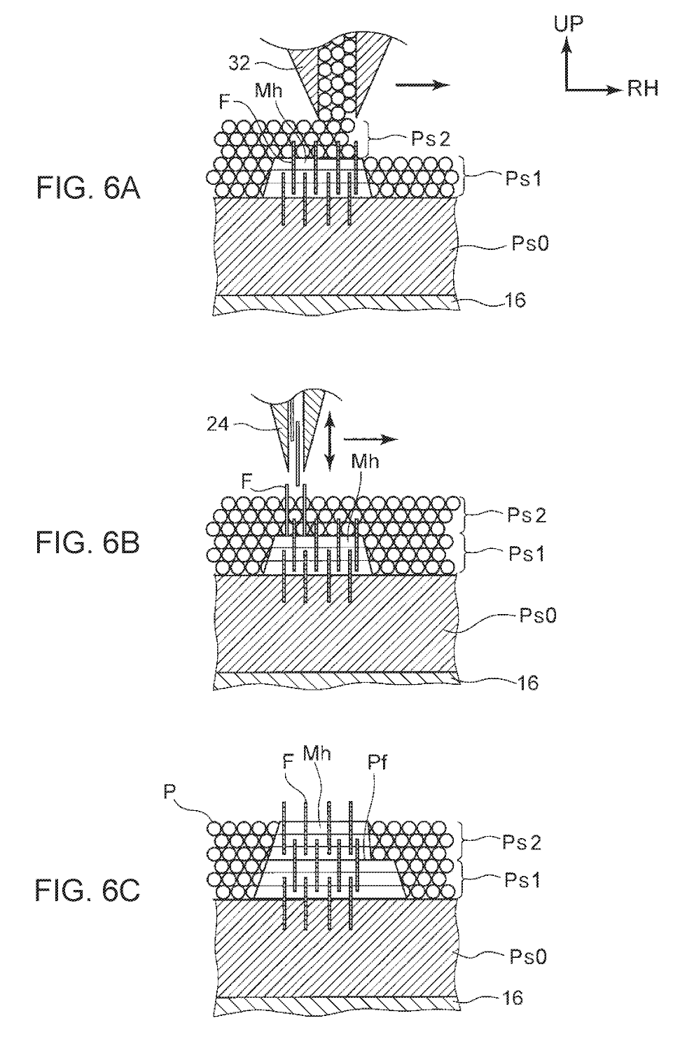

Then, as shown in FIG. 6A, the coater 32 discharges the resin powder P while moving in the radial direction from the one end portion to the other end portion at the upper side of the molding tank 12 again. Accordingly, a resin layer Ps2 is formed on the resin layer Ps1. Then, after the resin layer Ps2 is formed, the coater 32 moves to return to the one end portion of the molding tank 12, and the nozzle member 24 supplies plural fibers F to the resin layer Ps2 as shown in FIG. 6B.

Then, the fibers F are heated and molted by the laser beam Lf, which is emitted from the laser device 30 and provides scanning while reflected by the reflector 31, and the fibers F are fixed to the resin layer Ps2. Then, as shown in FIG. 6C, the area supplied with the fibers F in the resin layer Ps2 is molten or sintered and solidified (the solidified portion Mh is increased) by the laser beam Lc, which is emitted from the laser device 20 and provides scanning while reflected by the reflector 21.

By successively repeating the above-described steps, the three-dimensional molded part M as shown in FIG. 4 is formed in the molding tank 12. Although the illustration is omitted, as the resin powder P discharged from the coater 32 is laminated on the molding table 16, the molding table 16 is gradually moved downward by the up/down moving device 18.

Also, as shown in FIG. 6C, the nozzle member 24 supplies all the fibers F so that the fibers F extend over a layer interface Pf between the resin layer Ps1 and the resin layer Ps2 formed in the molding tank 12 (the layer interface Pf of the solidified portion Mh solidified by the laser beam Lc). Accordingly, as compared with a configuration in which the nozzle member 24 does not supply the fibers F so that the fibers F extend over the layer interface Pf between the resin layer Ps1 and the resin layer Ps2 formed in the molding tank 12, the molding strength and molding accuracy of the three-dimensional molded part M are increased.

The additive manufacturing apparatus 10 according to each of the exemplary embodiments is described above with reference to the drawings; however, the additive manufacturing apparatus 10 according to any one of the exemplary embodiments is not limited to the illustrated configuration, and may be properly changed in design within the scope of the invention. For example, the coater 32 may be used instead of the screen member 22 in the first exemplary embodiment, and the screen member 22 may be used instead of the coater 32 in the second exemplary embodiment.

Also, the nozzle member 24 does not have to be rotatable around the direction intersecting with the up-down direction as the axial direction. For example, plural nozzle members 24 with different supply directions may be arranged and the nozzle members 24 may be properly selectively used, to change the angle (the supply direction) of the fibers F to be supplied to the area where the three-dimensional molded part M is formed.

Further, the nozzle member 24 does not have to eject and supply the plural fibers F at once, and may eject and supply the fibers F one by one. Also, the shape of the molding tank 12 does not have to be a cylindrical shape, and may be, for example, a rectangular tubular shape. Also, the solidifying unit is not limited to the laser device 20 that emits a laser beam of a carbon dioxide laser.

Further, in the second exemplary embodiment, the coater 32 does not have to temporarily stop at the other end portion of the molding tank 12 and move to return to the one end portion of the molding tank 12. For example, the coater 32 may discharge the resin powder P while reciprocating between the one end portion and the other end portion of the molding tank 12. Also, the heating unit is not limited to the laser device 30 that emits a laser beam of a fiber laser.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An additive manufacturing apparatus comprising:
a discharging unit that discharges resin powder into a molding tank;
a supplying unit that supplies a fiber into the molding tank; and
a solidifying unit that solidifies at least part of a resin layer including the fiber and formed in the molding tank.

2. The additive manufacturing apparatus according to claim 1, further comprising a heating unit that heats the fiber.

3. The additive manufacturing apparatus according to claim 1, wherein the fiber supplied by the supplying unit is coated with a coating material made of resin.

4. The additive manufacturing apparatus according to claim 1, wherein the supplying unit is able to change a supply direction.

5. The additive manufacturing apparatus according to claim 1, wherein the supplying unit supplies the fiber only to a region which is solidified by the solidifying unit.

6. The additive manufacturing apparatus according to claim 1, wherein the supplying unit supplies the fiber before the resin powder is discharged from the discharging unit.

7. The additive manufacturing apparatus according to claim 1, wherein the supplying unit supplies the fiber after the resin powder is discharged from the discharging unit.

8. The additive manufacturing apparatus according to claim 1, wherein the supplying unit supplies the fiber after the solidification of the resin layer by the solidifying unit is started and before the solidification of the resin layer is completed.

9. The additive manufacturing apparatus according to claim 1, wherein the supplying unit supplies the fiber so that the fiber extends over a layer interface of the resin layer formed in the molding tank.

10. The additive manufacturing apparatus according to claim 1, wherein the resin powder is powder of thermoplastic resin.

11. An additive manufacturing method comprising:
discharging resin powder into a molding tank;
supplying a fiber into the molding tank; and
solidifying at least part of a resin layer including the fiber and formed in the molding tank.
